(19) United States
(12) Patent Application Publication
(10) Pub. No.: US 2020/0198624 A1
(43) Pub. Date: Jun. 25, 2020

(54) VEHICLE TRAVEL ASSIST DEVICE

(71) Applicant: TOYOTA JIDOSHA KABUSHIKI KAISHA, Toyota-shi (JP)

(72) Inventor: Kosuke AKATSUKA, Susono-shi (JP)

(73) Assignee: TOYOTA JIDOSHA KABUSHIKI KAISHA, Toyota-shi (JP)

(21) Appl. No.: 16/658,336

(22) Filed: Oct. 21, 2019

(30) Foreign Application Priority Data
Dec. 21, 2018 (JP) 2018-239771

(51) Int. Cl. B60W 30/085; B60W 30/18; B60W 40/06

(52) U.S. Cl. CPC B60W 30/085; B60W 2720/30; B60W 40/06; B60W 30/18009

(57) ABSTRACT

A vehicle travel assist device includes a control device that controls travel of a vehicle, and a memory device in which travel state information of the vehicle is stored. The control device executes vehicle guidance control that guides the vehicle to a target stop position based on the travel state information. During the vehicle guidance control, the control devices executes driving force increase control that increases a driving force such that a wheel of the vehicle climbs over a difference-in-level. The control device variably sets an increase rate of the driving force in the driving force increase control according to a remaining distance to the target stop position. The increase rate in a case where the remaining distance is a first distance is higher than the increase rate in a case where the remaining distance is a second distance shorter than the first distance.

### BACKGROUND

### Technical Field

The present disclosure relates to a vehicle travel assist device that assists vehicle travel. In particular, the present disclosure relates to a vehicle travel assist device that controls a driving force when a vehicle passes a difference-in-level.

### Background Art

Patent Literature 1 discloses a braking/driving force control device that controls a braking force and a driving force of a vehicle to guide the vehicle to a target position. When the vehicle comes into contact with a difference-in-level and a vehicle speed is decreased, the braking/driving force control device increases the driving force. When the vehicle climbs over the difference-in-level, the braking/driving force control device applies the braking force.

### List of Related Art

Patent Literature 1: Japanese Unexamined Patent Application Publication No. JP-2012-210916

### SUMMARY

Vehicle guidance control that guides a vehicle to a target stop position is considered. During the vehicle guidance control, increase in a driving force may be required for a wheel of a vehicle to climb over a difference-in-level (see Patent Literature 1). In that case, if the driving force is increased more than necessary, the vehicle may go beyond the target stop position after the wheel climbs over the difference-in-level. This causes decrease in confidence in the vehicle guidance control, which is not preferable.

An object of the present disclosure is to provide a technique that can efficiently execute the vehicle guidance control with suppressing a vehicle from going beyond a target stop position in the vehicle guidance control.

A first aspect relates to a vehicle travel assist device that assists travel of a vehicle.

The vehicle travel assist device includes:

a control device configured to control the travel of the vehicle; and

a memory device in which travel state information indicating a travel state of the vehicle is stored.

The control device is further configured to:

execute vehicle guidance control that guides the vehicle to a target stop position based on the travel state information;

during the vehicle guidance control, execute driving force increase control that increases a driving force such that a wheel of the vehicle climbs over a difference-in-level; and

variably set an increase rate of the driving force in the driving force increase control according to a remaining distance to the target stop position at a time of the driving force increase control.

The increase rate in a case where the remaining distance is a first distance is higher than the increase rate in a case where the remaining distance is a second distance shorter than the first distance.

A second aspect relates to a vehicle travel assist device that assists travel of a vehicle.

The vehicle travel assist device includes:

a control device configured to control the travel of the vehicle; and

a memory device in which travel state information indicating a travel state of the vehicle is stored.

The control device is further configured to:

execute vehicle guidance control that guides the vehicle to a target stop position based on the travel state information;

during the vehicle guidance control, execute driving force increase control that increases a driving force such that a wheel of the vehicle climbs over a difference-in-level; and

variably set a target value of the driving force in the driving force increase control according to a remaining distance to the target stop position at a time of the driving force increase control.

The target value in a case where the remaining distance is a first distance is greater than the target value in a case where the remaining distance is a second distance shorter than the first distance.

According to the first aspect, the control device variably sets the increase rate of the driving force in the driving force increase control according to the remaining distance to the target stop position at the time of the driving force increase control.

More specifically, when the remaining distance is relatively short, the increase rate of the driving force is set relatively low. Since the increase rate is low, the driving force is suppressed from increasing more than necessary. That is, occurrence of overshoot of the driving force is suppressed. As a result, the vehicle is suppressed from going beyond the target stop position after the wheel climbs over the difference-in-level.

On the other hand, when the remaining distance is relatively long, the increase rate of the driving force is set relatively high. In this case, overshoot of the driving force may occur. However, since the remaining distance to the target stop position is long, the vehicle does not go beyond the target stop position. Furthermore, since the increase rate of the driving force is high, a transit time required for the wheel to pass the difference-in-level is reduced. Since the transit time is reduced, the vehicle promptly reaches the target stop position. This means that the vehicle guidance control is executed more efficiently.

According to the second aspect, the control device variably sets the target value of the driving force in the driving force increase control according to the remaining distance to the target stop position at the time of the driving force increase control.

More specifically, when the remaining distance is relatively short, the target value of the driving force is set relatively small. Therefore, the driving force is suppressed from increasing more than necessary. That is, occurrence of overshoot of the driving force is suppressed. As a result, the vehicle is suppressed from going beyond the target stop position after the wheel climbs over the difference-in-level.

On the other hand, when the remaining distance is relatively long, the target value of the driving force is set relatively large. In this case, overshoot of the driving force may occur. However, since the remaining distance to the target stop position is long, the vehicle does not go beyond the target stop position. Moreover, when the target value of the driving force is large, the driving force after the wheel climbs over the difference-in-level is large as well. Therefore, the vehicle promptly reaches the target stop position. This means that the vehicle guidance control is executed more efficiently.

### BRIEF DESCRIPTION OF DRAWINGS

FIG. 1 is a conceptual diagram for explaining an outline of a vehicle travel assist device according to a first embodiment of the present disclosure;

FIG. 2 is a conceptual diagram for explaining an example of vehicle guidance control by the vehicle travel assist device according to the first embodiment;

FIG. 3 is a conceptual diagram for explaining another example of the vehicle guidance control by the vehicle travel assist device according to the first embodiment;

FIG. 4 is a conceptual diagram for explaining a tradeoff in driving force increase control;

FIG. 5 is a conceptual diagram for explaining a trade-off in the driving force increase control;

FIG. 6 is a conceptual diagram for explaining an outline of the driving force increase control according to the first embodiment;

FIG. 7 is a conceptual diagram for explaining an example of the driving force increase control according to the first embodiment;

FIG. 8 is a block diagram showing a configuration example of the vehicle travel assist device according to the first embodiment;

FIG. 9 is a block diagram showing an example of travel state information used in the first embodiment;

FIG. 10 is a conceptual diagram for explaining target information used in the first embodiment;

FIG. 11 is a conceptual diagram for explaining vehicle position information in the first embodiment;

FIG. 12 is a flow chart showing processing according to the first embodiment;

FIG. 13 is a flow chart showing the vehicle guidance control (Step S200) according to the first embodiment;

FIG. 14 is a conceptual diagram for explaining an example of a method of detecting difference-in-level passing in the first embodiment;

FIG. 15 is a flow chart showing processing according to a second embodiment of the present disclosure; and

FIG. 16 is a conceptual diagram for explaining the driving force increase control according to the second embodiment of the present disclosure.

### EMBODIMENTS

Embodiments of the present disclosure will be described below with reference to the attached drawings.

### First Embodiment

### 1. Outline

### 1-1. Vehicle Travel Assist Device

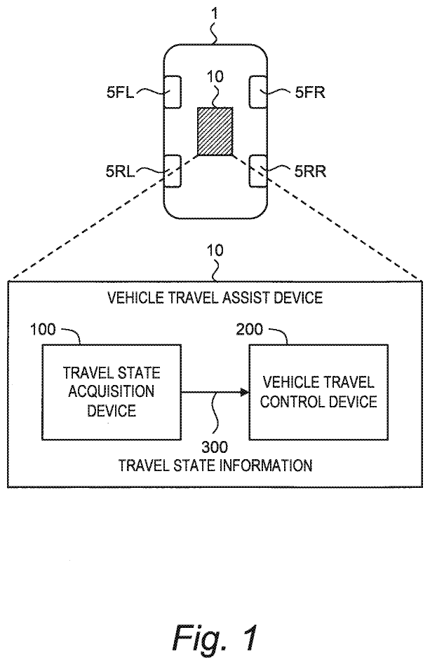

FIG. 1 is a conceptual diagram for explaining an outline of a vehicle travel assist device 10 according to a first embodiment of the present disclosure. The vehicle travel assist device 10 is installed on a vehicle 1. The vehicle 1 is provided with a plurality of wheels 5. More specifically, the vehicle 1 is provided with a left front wheel 5FL, a right front wheel 5FR, a left rear wheel 5RL, and a right rear wheel 5RR. In the following description, the left front wheel 5FL and the right front wheel 5FR may be collectively referred to as a “front wheel 5F”, and the left rear wheel 5RL and the right rear wheel 5RR may be collectively referred to as a “rear wheel 5R”.

As shown in FIG. 1, the vehicle travel assist device 10 includes a travel state acquisition device 100 and a vehicle travel control device 200. The travel state acquisition device 100 acquires travel state information 300 indicating a travel state of the vehicle 1. The travel state of the vehicle 1 is exemplified by a position, a speed (a vehicle speed), an acceleration, a steering angle, a driving force, a braking force, a surrounding situation, and the like. The vehicle travel control device 200 executes “vehicle travel control” that controls travel of the vehicle 1 based on the travel state information 300. The vehicle travel control includes driving force control, braking force control, and steering control.

### 1-2. Vehicle Guidance Control

The vehicle travel control device 200 assists (supports) the travel of the vehicle 1 through the vehicle travel control. In particular, the vehicle travel control device 200 executes “vehicle guidance control” that automatically moves and guides the vehicle 1 to a target stop position. Such the vehicle guidance control is utilized, for example, when parking the vehicle 1 at a desired parking position. Moreover, the vehicle guidance control can be utilized in automated driving.

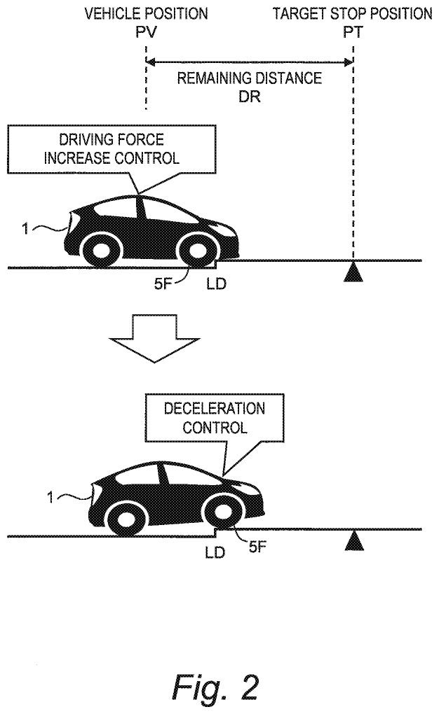

FIG. 2 is a conceptual diagram for explaining an example of the vehicle guidance control. A target stop position PT is a target position at which the vehicle 1 is stopped, and is set in advance. A vehicle position PV is a position of the vehicle 1 and changes as the vehicle 1 moves. A remaining distance DR is a distance from the vehicle position PV to the target stop position PT.

In the vehicle guidance control, the vehicle travel control device 200 guides the vehicle 1 to the target stop position PT. In other words, the vehicle travel control device 200 moves the vehicle 1 until the vehicle position PV becomes the target stop position PT. In still other words, the vehicle travel control device 200 moves the vehicle 1 until the remaining distance DR becomes zero. The vehicle position PV and the remaining distance DR can be calculated from the driving state information 300. Therefore, the vehicle travel control device 200 can execute the vehicle guidance control based on the travel state information 300.

### 1-3. Difference-in-Level and Driving Force Increase Control

Hereinafter, a case where a difference-in-level LD exists before the target stop position PT as shown in. FIG. 2 will be considered. The vehicle travel control device 200 executes the vehicle guidance control such that the wheel 5 of the vehicle 1 appropriately passes the difference-in-level LD. Here, “the wheel 5 passing the difference-in-level LD” means that the wheel 5 reaches (i.e. comes into contact with) the difference-in-level LD and further climbs over the difference-in-level LD.

Increase in a driving force F of the vehicle 1 may be required for the wheel 5 to climb over the difference-in-level LD. In the example shown in FIG. 2, the front wheel 5F comes into contact with the difference-in-level LD, and thereby the vehicle 1 is stopped. In that case, the vehicle travel control device 200 increases the driving force F of the vehicle 1 such that the front wheel 5F climbs over the difference-in-level LD. Such the processing is hereinafter referred to as “driving force increase control”.

The driving force increasing control causes the front wheel 5F to climb over the difference-in-level LD. After that, the driving force F required for climbing over becomes unnecessary. In order to prevent the vehicle 1 from unnecessarily accelerating, the vehicle travel control device 200 executes “deceleration control”. In the deceleration control, the vehicle travel control device 200 decreases the driving force F. In addition, the vehicle travel control device 200 may apply a braking force as necessary.

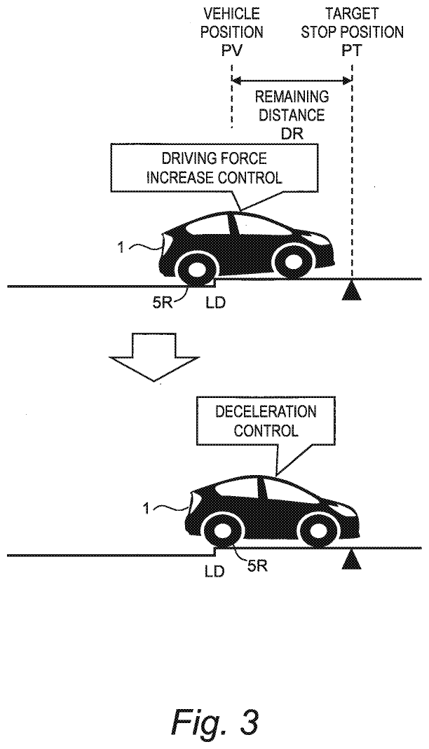

Similarly, in an example shown in FIG. 3, the rear wheel 5R comes into contact with the difference-in-level LD, and thereby the vehicle 1 is stopped. The vehicle travel control device 200 executes the driving force increase control such that the rear wheel 5R climbs over the difference-in-level LD. After the rear wheel 5R climbs over the difference-in-level LD, the vehicle travel control device 200 executes the deceleration control.

It should be noted in the present embodiment that a shape of the difference-in-level LD is not limited in particular. For example, the shape of the difference-in-level LD includes a step shape, a slope shape, and a bump shape.

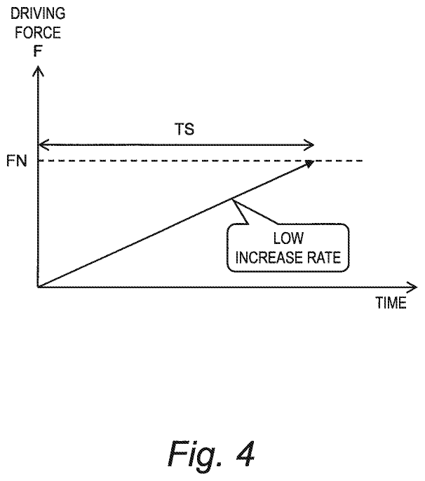

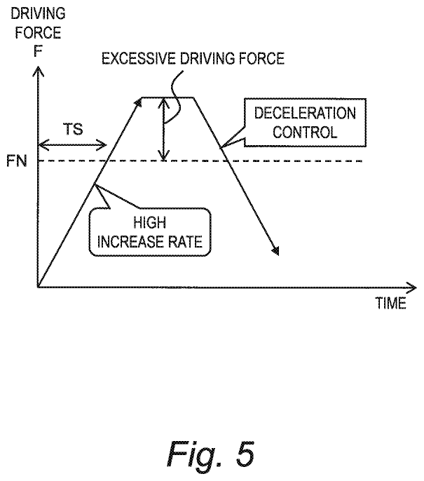

Next, a trade-off in the driving force increase control will be described with reference to FIGS. 4 and 5. In FIGS. 4 and 5, a horizontal axis represents time, and a vertical axis represents the driving force F. A minimum required driving force FN is the minimum driving force F required for the wheel 5 to climb over the difference-in-level LD. When the driving force F is increased to the minimum required driving force FN, the wheel 5 climbs over the difference-in-level LD.

An increase rate RI of the driving force F is a time rate of change in the driving force F in the driving force increase control. The increase rate RI can also be referred to as a slope of increase or a rate of increase. In the example shown in FIG. 4, the increase rate RI is relatively low. Since the driving force F is increased slowly, a transit time TS required for the wheel 5 to pass the difference-in-level LD becomes longer. In the example shown in FIG. 5, on the other hand, the increase rate RI is relatively high. Since the driving force F is increased rapidly, the transit time TS is reduced as compared with the case shown in FIG. 4. That is, the vehicle guidance control is efficiently executed.

However, the deceleration effect due to the deceleration control does not always occur immediately after the wheel 5 climbs over the difference-in-level LD. For example, a certain amount of time is required for detecting by the use of a sensor that the wheel 5 climbs over the difference-in-level LD. Moreover, there is also a response delay of an actuator used for the deceleration control. Due to these factors, there is a time lag from when the wheel 5 climbs over the difference-in-level LD to when the vehicle 1 actually starts decelerating.

Thus, when the increase rate RI in the driving force increase control is high, as shown in FIG. 5, the driving force F greatly exceeds the minimum required driving force FN before the deceleration of the vehicle 1 starts. That is, an excessive driving force F (i.e. overshoot) is caused. In that case, the vehicle 1 may not return to low speed immediately after the wheel 5 climbs over the difference-in-level LD, and thus the vehicle 1 may go beyond the target stop position PT. This causes decrease in confidence in the vehicle guidance control, which is not preferable.

In view of the above, the present embodiment proposes the driving force increase control that can execute the vehicle guidance control as efficiently as possible with suppressing the vehicle 1 from going beyond the target stop position PT.

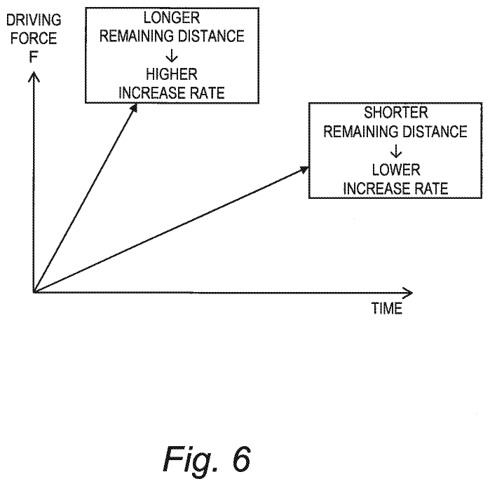

FIG. 6 is a conceptual diagram for explaining an outline of the driving force increase control according to the present embodiment. A horizontal axis represents time, and a vertical axis represents the driving force F. The vehicle travel control device 200 variably (flexibly) sets the increase rate RI of the driving force F according to the remaining distance DR (see FIGS. 2 and 3) to the target stop position PT at the time of the driving force increase control. More specifically, when the remaining distance DR at the time of the driving force increase control is relatively short, the increase rate RI is set to be relatively low. Conversely, when the remaining distance DR at the time of the driving force increase control is relatively long, the increase rate RI is set to be relatively high. In other words, the increase rate RI in a case where the remaining distance DR is a first distance is higher than the increase rate RI in a case where the remaining distance DR is a second distance shorter than the first distance.

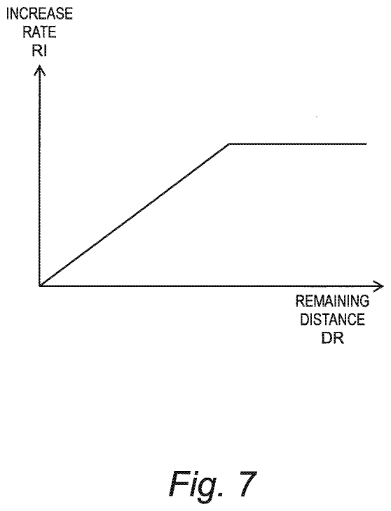

FIG. 7 is a conceptual diagram for explaining an example of the driving force increase control according to the present embodiment. A horizontal axis represents the remaining distance DR at the time of the driving force increase control, and a vertical axis represents the increase rate RI of the driving force F. As the remaining distance DR increases, the increase rate RI becomes higher. It should be noted that the increase rate RI does not necessarily have to increase monotonically in accordance with the remaining distance DR. For example, the increase rate RI may increase stepwise as the remaining distance DR increases. As another example, a predetermined upper limit may be provided for the increase rate RI. When the remaining distance DR becomes equal to or longer than the predetermined value, the increase rate RI is maintained at the predetermined upper limit.

### 1-4. Effects

According to the present embodiment, as described above, the vehicle travel control device 200 variably sets the increase rate RI of the driving force F in the driving force increase control according to the remaining distance DR to the target stop position PT at the time of the driving force increase control.

More specifically, when the remaining distance DR is relatively short, the increase rate RI is set relatively low. Since the increase rate RI is low, occurrence of the overshoot of the driving force F as shown in FIG. 5 is suppressed. As a result, the vehicle 1 is suppressed from going beyond the target stop position PT after the wheel 5 climbs over the difference-in-level LD.

On the other hand, when the remaining distance DR is relatively long, the increase rate RI is set relatively high. In this case, the overshoot of the driving force F as shown in FIG. 5 may occur. However, since the remaining distance DR to the target stop position PT is long, the vehicle 1 does not go beyond the target stop position PT. Therefore, the overshoot of the driving force F is permissible. Furthermore, since the increase rate RI is high, the transit time TS required for the wheel 5 to pass the difference-in-level LD is reduced. Since the transit time TS is reduced, the vehicle 1 promptly reaches the target stop position PT. In addition, the large driving force F after the wheel 5 climbs over the difference-in-level LD also contributes to the vehicle I promptly reaching the target stop position PT. These mean that the vehicle guidance control is executed more efficiently.

As described above, according to the present embodiment, the vehicle 1 is suppressed from going beyond the target stop position PT regardless of the remaining distance DR to the target stop position PT. Therefore, the confidence in the vehicle guidance control is increased. Furthermore, when the remaining distance DR to the target stop position PT is long, the vehicle guidance control can be executed more efficiently. As a result, convenience for a user of the vehicle 1 is increased. It can be said that the present embodiment achieves both “avoiding going beyond the target stop position PT” and “efficient vehicle guidance control”.

Hereinafter, the vehicle travel assist device 10 according to the present embodiment will be described in more detail.

### 2. Configuration Example of Vehicle Travel Assist Device

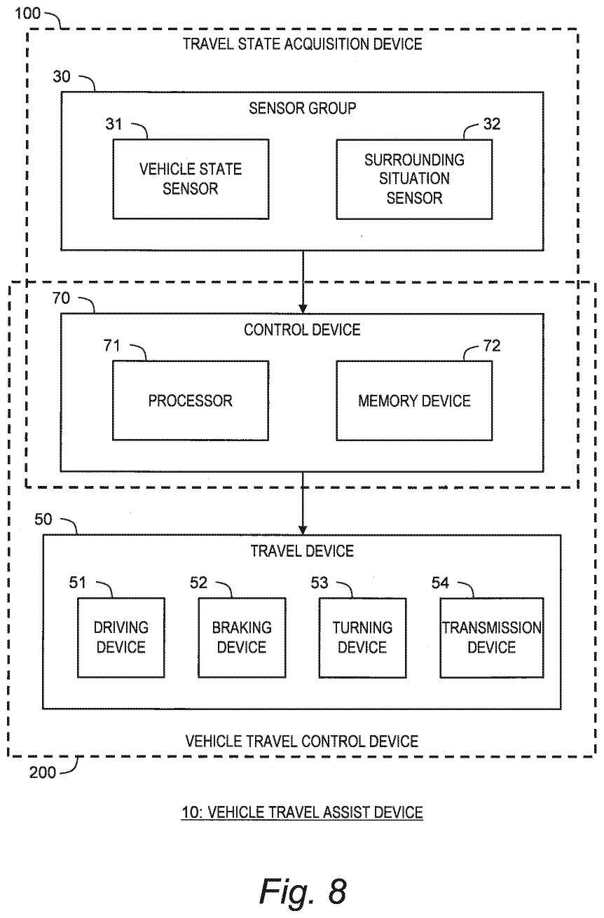

FIG. 8 is a block diagram showing a configuration example of the vehicle travel assist device 10 according to the present embodiment. The vehicle travel assist device 10 includes a sensor group 30, a travel device 50, and a control device (controller) 70.

The sensor group 30 includes a vehicle state sensor 31 and a surrounding situation sensor 32.

The vehicle state sensor 31 detects a state of the vehicle 1. The state of the vehicle 1 is exemplified by a wheel speed, a vehicle speed, an acceleration (a longitudinal acceleration, a lateral acceleration, and a vertical acceleration), a steering angle, a suspension stroke amount, and the like. The vehicle state sensor 31 includes a wheel speed sensor, a vehicle speed sensor, a variety of acceleration sensors, a steering angle sensor, a stroke sensor, and the like. The vertical acceleration sensor and the stroke sensor are provided at a position of each wheel 5, for example. The vehicle state sensor 31 may further include a GPS (Global Positioning System) device that measures a position and an orientation of the vehicle 1.

The surrounding situation sensor 32 detects a situation around the vehicle 1. For example, the surrounding situation sensor 32 includes a camera, a sonar, a LIDAR (Laser Imaging Detection and Ranging), and the like. Using the surrounding situation sensor 32 makes it possible to perceive (recognize) space and objects around the vehicle 1.

The travel device 50 includes a driving device 51, a braking device 52, a turning device 53, and a transmission device 54. The driving device 51 is a power source that generates the driving force. The driving device 51 is exemplified by an engine, an electric motor, and an in-wheel motor. The braking device 52 generates a braking force. The turning device 53 turns (i.e. changes a direction of) the wheel 5. For example, the turning device 53 includes a power steering device (e.g., EPS: Electric Power Steering).

The control device 70 (the controller) is a microcomputer provided with a processor 71 and a memory device 72. The control device 70 is also called an ECU (Electronic Control Unit). A control program is stored in the memory device 72. A variety of processing by the control device 70 is achieved by the processor 71 executing the control program stored in the memory device 72.

For example, the control device 70 (i.e. the processor 71) executes the vehicle travel control by appropriately controlling an operation of the travel device 50. The vehicle travel control includes driving force control, braking force control, steering control, and gear control. The driving force control is performed through the driving device 51. The braking force control is performed through the braking device 52. The steering control is performed through the turning device 53. The gear control is performed through the transmission device 54. It can be said that the control device 70 and the travel device 50 constitute the “vehicle travel control device 200” shown in FIG. 1.

Moreover, the control device 70 (i.e. the processor 71) acquires the travel state information 300 indicating the travel state of the vehicle 1, based on results of detection by the sensor group 30, and the like. The sensor group 30 and the control device 70 constitute the “travel state acquisition device 100” shown in FIG. 1. Hereinafter, a concrete example of the travel state information 300 will be described.

### 3. Example of Travel State Information

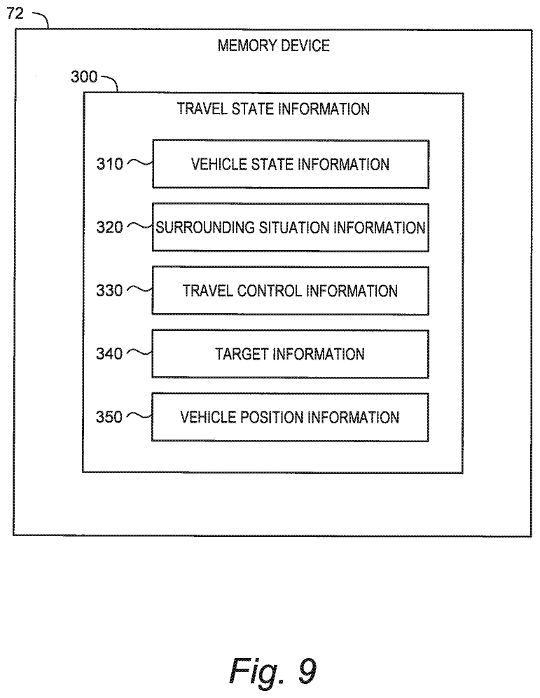

FIG. 9 is a block diagram showing an example of the travel state information 300 used in the present embodiment. The travel state information 300 is stored in the memory device 72 and used in the vehicle travel control. As shown in FIG. 9, the travel state information 300 includes vehicle state information 310, surrounding situation information 320, travel control information 330, target information 340, and vehicle position information 350.

### 3-1. Vehicle State Information 310

The vehicle state information 310 indicates the state of the vehicle 1. The control device 70 acquires the vehicle state information 310 based on a result of detection by the vehicle state sensor 31. The state of the vehicle 1 is exemplified by the wheel speed, the vehicle speed, the acceleration (the longitudinal acceleration, the lateral acceleration, and the vertical acceleration), the steering angle, the suspension stroke amount, and the like. As to the vertical acceleration and the suspension stroke amount, their values at the position of each wheel 5 are calculated.

When the vehicle state sensor 31 includes the GPS device, the vehicle state information 310 may include position information regarding the vehicle 1 that is acquired by the GPS device.

### 3-2. Surrounding Situation Information 320

The surrounding situation information 320 indicates the situation around the vehicle 1. The control device 70 acquires the surrounding situation information 320 based on a result of detection by the surrounding situation sensor 32. For example, the surrounding situation information 320 includes image information obtained by the camera. Moreover, the surrounding situation information 320 includes object information regarding a surrounding object (e.g. a wall) measured by the sonar and the LIDAR. The object information indicates a relative position of the surrounding object (i.e. a distance to the surrounding object). The object information may further indicate a relative velocity.

The difference-in-level LD near the vehicle 1 may be detected by the surrounding situation sensor 32. In that case, the surrounding situation information 320 may include information indicating a relative position of the detected difference-in-level LD.

### 3-3. Travel Control Information 330

The travel control information 330 indicates a control amount of the travel device 50 controlled by the control device 70. For example, the travel control information 330 indicates the driving force and the braking force that are controlled by the control device 70.

### 3-4. Target Information 340

The target information 340 indicates the target stop position PT for the vehicle guidance control. The target stop position PT is beforehand set manually or by the control device 70.

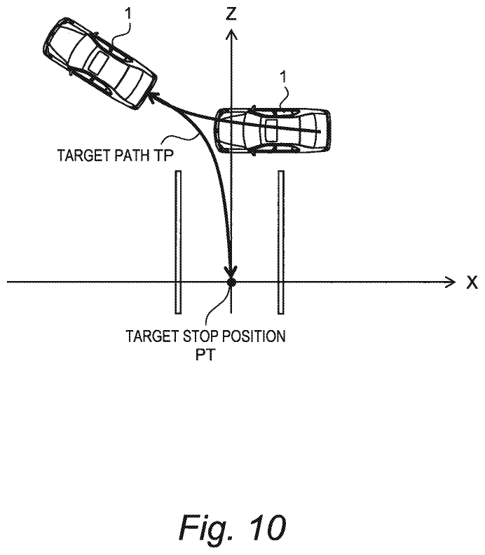

As an example, FIG. 10 illustrates a case where the vehicle 1 is to be parked at a desired parking position. The control device 70 automatically determines an appropriate target stop position PT based on the above-described surrounding situation information 320. Alternatively, the control device 70 displays information indicating space and objects around the vehicle 1 on an HMI (Human Machine Interface), based on the surrounding situation information 320. Then, a user of the vehicle 1 refers to the displayed information to designate a desired target stop position PT.

After the target stop position PT is set, the control device 70 may generate a target path TP from a current position of the vehicle 1 to the target stop position PT. The target path TP is defined, for example, in a coordinate system whose origin is at the target stop position PT. When the target path TP is generated, the target information 340 indicates the target stop position PT and the target path TP. The control device 70 (i.e. the vehicle travel control device 200) executes the vehicle travel control such that the vehicle 1 travels along the target path TP.

### 3-5. Vehicle Position Information 350

The vehicle position information 350 indicates the vehicle position PV being the position of the vehicle 1. The vehicle position information 350 may further indicate a position of each wheel 5.

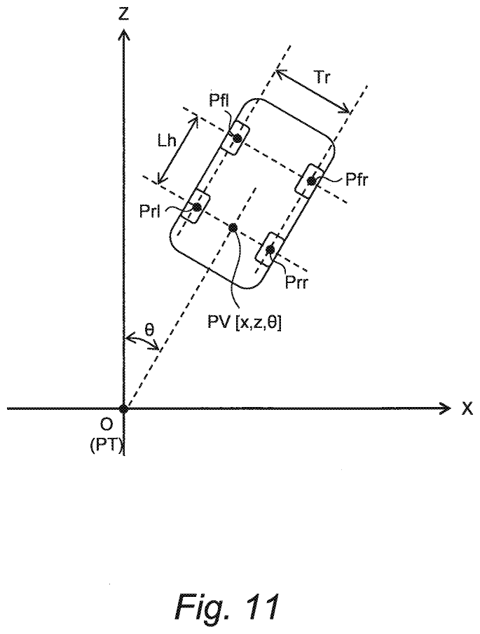

FIG. 11 is a conceptual diagram for explaining the vehicle position information 350. The positions of the vehicle 1 and each wheel 5 are defined in a predetermined coordinate system. For example, a coordinate system whose origin O is at the above-described target stop position PT is used as the predetermined coordinate system. However, the predetermined coordinate system is not limited to that.

In FIG. 11, the vehicle position PV[x, z, θ] represents a representative position of the vehicle 1. For example, an intermediate position between the left rear wheel 5RL and the right rear wheel 5RR is used as the vehicle position PV. Wheel positions Pfl, Pfr, Prl, and Prr represent respective positions of the left front wheel 5FL, the right front wheel 5FR, the left rear wheel 5RL, and the right rear wheel 5RR. A wheelbase Lh and a track width Tr are known parameters. The wheel positions Pfl, Pfr, Prl, and Prr can be calculated from the vehicle position PV and the known parameters.

During the vehicle guidance control, the control device 70 calculates and updates the vehicle position PV and each wheel position based on the vehicle state information 310. More specifically, the vehicle state information 310 includes the steering angle and the wheel speed. Based on the steering angle and the wheel speed, the control device 70 can calculate an amount of movement of the vehicle 1 to sequentially calculate and update the vehicle position PV. When the vehicle position PV is updated, each wheel position also is updated.

As another example, when the vehicle state information 310 includes the position information regarding the vehicle 1 that is acquired by the GPS device, the control device 70 may utilize the position information. As still another example, the control device 70 may calculate and update the vehicle position PV based on the relative position with respect to the surrounding object (e.g. a wall) indicated by the surrounding situation information 320.

### 4. Process Flow

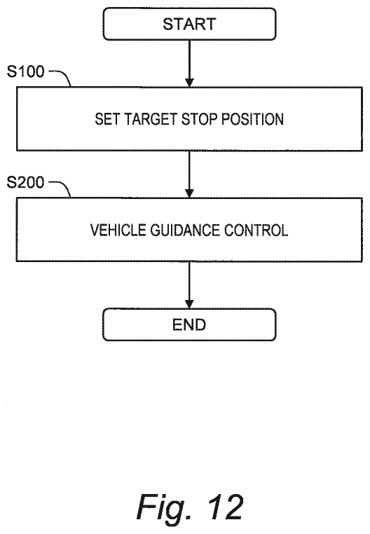

FIG. 12 is a flow chart showing processing according to the present embodiment. First, the target stop position PT for the vehicle guidance control is set (Step S100). As described above, the target stop position PT is set manually or by the control device 70. The control device 70 may generate the target path TP from a current position of the vehicle 1 to the target stop position PT (see FIG. 10).

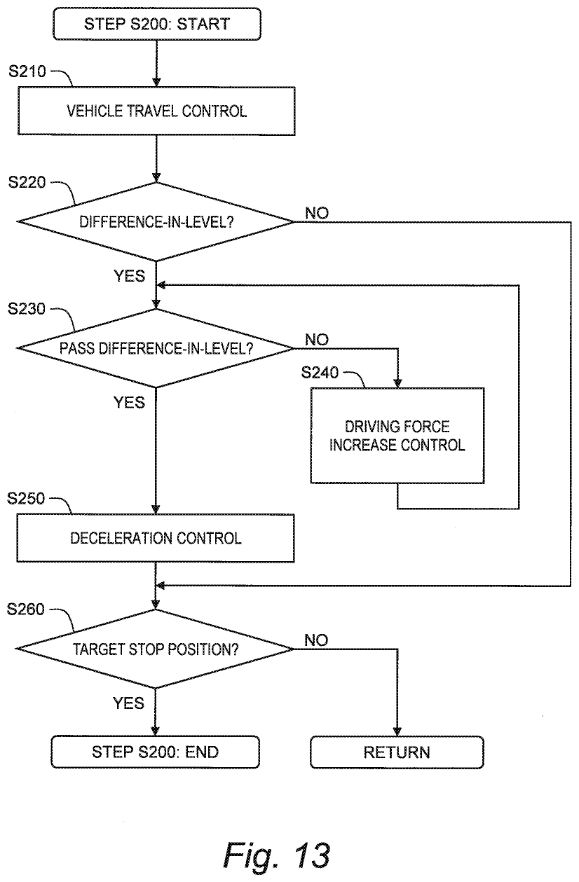

After the target stop position PT is set, the control device 70 (the controller) executes the vehicle guidance control that guides the vehicle 1 to the target stop position PT (Step S200). FIG. 13 is a flow chart showing the vehicle guidance control (Step S200). It should be noted that the travel state information 300 is updated every certain cycle and stored in the memory device 72.

### 4-1. Step S210

In Step S210, the control device 70 executes the vehicle travel control based on the travel state information 300 such that the vehicle 1 approaches the target stop position PT. In the case where the target path TP is generated, the control device 70 executes the vehicle travel control such that the vehicle 1 travels along the target path TP.

Moreover, the control device 70 updates the vehicle position information 350 based on the travel state information 300 (specifically, the vehicle state information 310). A method of updating the vehicle position information 350 is as described above. Updating the vehicle position PV is equivalent to updating the remaining distance DR to the target stop position PT. It can be said that the control device 70 executes the vehicle travel control (the vehicle guidance control) with updating the remaining distance DR to the target stop position PT.

### 4-2. Step S220

In Step S220, the control device 70 determines, based on the travel state information 300, whether or not any wheel 5 reaches (i.e. comes into contact with) the difference-in-level LD.

Typically, when the wheel 5 reaches the difference-in-level LD, the vehicle 1 is stopped despite generation of the driving force. Therefore, the control device 70 can detect that the wheel 5 reaches the difference-in-level LD, based OD the vehicle state information 310 (the vehicle speed) and the travel control information 330 (the driving force)

As another example, it is also possible that the surrounding situation sensor 32 (e.g. the LIDAR) detects the difference-in-level LD. In that case, the surrounding situation information 320 includes relative position information of the detected difference-in-level LD. The control device 70 can estimate that any wheel 5 reaches the difference-in-level LD, based on the vehicle position information 350 and the surrounding situation information 320.

When it is determined that any wheel 5 reaches the difference-in-level LD (Step S220; Yes), the processing proceeds to Step S230. Otherwise (Step S220; No), the processing proceeds to Step S260.

### 4-3. Step S230

In Step S230, the control device 70 determines, based on the travel state information 300, whether or not the wheel 5 passes the difference-in-level LD.

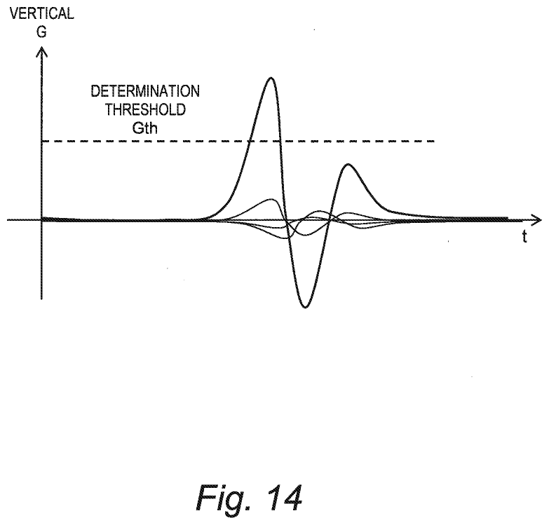

FIG. 14 is a conceptual diagram for explaining an example of a method of detecting the difference-in-level passing. A horizontal axis represents time, and a vertical axis represents the vertical acceleration at the position of each wheel 5. The vertical acceleration is obtained from the vehicle state information 310. When the vertical acceleration at a position of a certain wheel 5 exceeds a determination threshold Gth, the control device 70 determines that said certain wheel 5 passes the difference-in-level LD. In this manner, it is possible by referring to the vertical acceleration to detect that any wheel 5 passes the difference-in-level LD and identify the wheel 5 that passes the difference-in-level LD. The suspension stroke amount may be taken into consideration instead of or together with the vertical acceleration.

As another example, the control device 70 may detect the difference-in-level passing based on changes in the vehicle speed and the longitudinal acceleration indicated by the vehicle state information 310. As still another example, the control device 70 may detect the difference-in-level passing based on a change in the camera's field of vision indicated by the surrounding situation information 320.

When it is determined that the wheel 5 passes the difference-in-level LD (Step S230; Yes), the processing proceeds to Step S250. Otherwise (Step S230; No), the processing proceeds to Step S240.

### 4-4. Step S240

In Step S240, the control device 70 executes the driving force increase control that increases the driving force F. Here, the control device 70 variably sets the increase rate RI of the driving force F according to the remaining distance DR to the target stop position PT. More specifically, when the remaining distance DR is relatively short, the increase rate RI is set to be relatively low. Conversely, when the remaining distance DR is relatively long, the increase rate RI is set to be relatively high. In other words, the increase rate RI in a case where the remaining distance DR is a first distance is higher than the increase rate RI in a case where the remaining distance DR is a second distance shorter than the first distance.

After that, the processing returns back to Step S230. That is, the driving force increase control is executed until the wheel 5 passes the difference-in-level LD. It should be noted that when the difference-in-level LD is sufficiently small in height, the wheel 5 may pass the difference-in-level LD without the driving force increase control.

### 4-5. Step S250

In Step S250, the control device 70 executes the deceleration control. More specifically, the control device 70 decreases the driving force F. In addition, the control device 70 may apply the braking force as necessary. After that, the processing proceeds to Step S260.

### 4-6. Step S260

In Step S260, the control device 70 determines, based on the travel state information 300, whether or not the vehicle 1 reaches the target stop position PT. That is, the control device 70 determines whether or not the remaining distance DR is zero. When the vehicle 1 does not yet reach the target stop position PT (Step S260; No), the processing returns back to Step S210. When the vehicle I reaches the target stop position PT (Step S260; Yes), the vehicle guidance control is terminated.

### Second Embodiment

In a second embodiment of the present disclosure, the minimum required driving force FN (see FIGS. 4 and 5) required for the wheel 5 to climb over the difference-in-level LD is estimated.

For the sake of explanation, let us define a “first wheel 5-1” and a “second wheel 5-2”. As the vehicle 1 moves, the plurality of wheels 5 reach the difference-in-level LD in series. The first wheel 5-1 is a wheel 5 that reaches the difference-in-level LD relatively early (i.e. a preceding wheel). The second wheel 5-2 is a wheel 5 that reaches the difference-in-level LD relatively late (i.e. a subsequent wheel). In the example shown in FIGS. 2 and 3, the front wheel 5F is the first wheel 5-1, and the rear wheel 5R is the second wheel 5-2. There may also be a case where the wheels 5 reach the difference-in-level LD one by one.

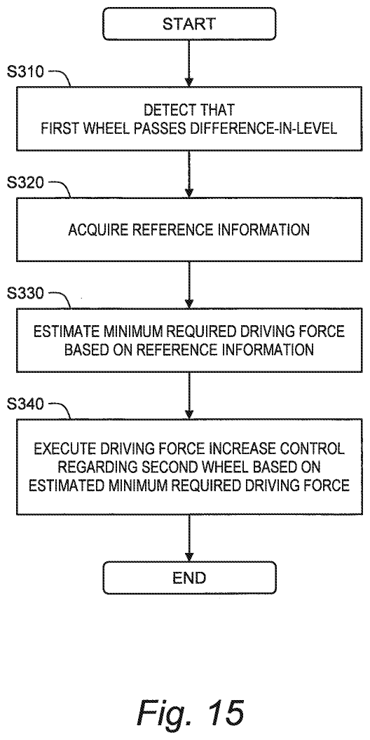

FIG. 15 is a flow chart showing processing according to the second embodiment.

In Step S310, the control device 70 detects the difference-in-level passing of the first wheel 5-1. The processing in Step S310 is similar to that in the above-described Steps S210 to S250.

In Step S320, the control device 70 acquires reference information regarding the driving force F when the first wheel 5-1 climbs over the difference-in-level LD. For example, a first driving force F1 is the driving force F that is actually required for the first wheel 5-1 to climb over the difference-in-level LD, and the first driving force F1 is used as the reference information. The control device 70 can acquire the first driving force F1 based on the travel control information 330.

In Step S330, the control device 70 estimates a second driving force F2 (i.e. the minimum required driving force FN) that is at least required for the second wheel 5-2 to climb over the difference-in-level LD.

Let us consider a first load W1 and a second load W2 for explaining estimation of the second driving force F2. The first load W1 is a load applied to the first wheel 5-1 concurrently passing the difference-in-level LD. The second load W2 is a load applied to the second wheel 5-2 concurrently passing the difference-in-level LD. There is a correlation between the first driving force F1 and the first load W1. Similarly, there is a correlation between the second driving force F2 and the second load W2. There is a relationship between the first load W1, the second load W2, the first driving force F1, and the second driving force F2 as expressed by the following Equation (1).

F2=F1×(W2/W1) Equation (1)

The first wheel 5-1 is identified in the above-described Step S310. The second wheel 5-2 is estimated based on the target information 340 (i.e. the target stop position PT, the target path TP), the vehicle position information 350 (i.e. the vehicle position PV, the wheel position), the vehicle state information 310 (the steering angle), and the like. A weight distribution of the vehicle 1 is known information. The first driving force F1 is obtained from the reference information acquired in the above-described Step S320. Therefore, the control device 70 can estimate the second driving force F2 based on the travel state information 300 and the reference information.

After the second driving force F2 is estimated, the second wheel 5-2 reaches the difference-in-level LD. In Step S340, the control device 70 executes the driving force increase control regarding the second wheel 5-2 in consideration of the estimated second driving force F2 (i.e. the minimum required driving force FN).

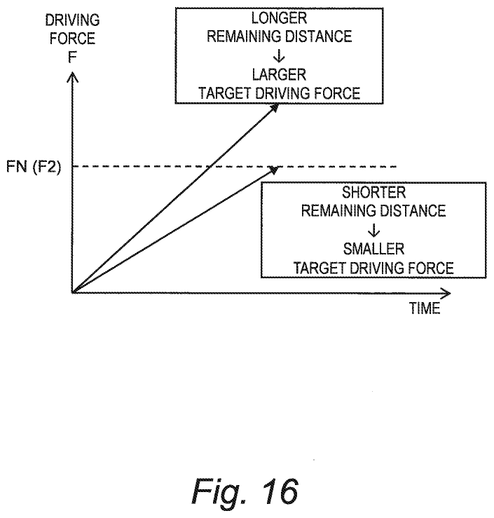

Specifically, the control device 70 sets a target driving force F* (a target value of the driving force F) in the driving force increase control to the second driving force F2 or greater. Here, the control device 70 variably (flexibly) sets the target driving force F* according to the remaining distance DR at the time of the driving force increase control. More specifically, as shown in FIG. 16, when the remaining distance DR is relatively short, the target driving force F* is set to be relatively small. Conversely, when the remaining distance DR is relatively long, the target driving force F* is set to be relatively large. In other words, the target driving force F* in a case where the remaining distance DR is a first distance is greater than the target driving force F* in a case where the remaining distance DR is a second distance shorter than the first distance.

As described above, when the remaining distance DR is relatively short, the target driving force F* is set relatively small. Therefore, occurrence of the overshoot of the driving force F as shown in FIG. 5 is suppressed. As a result, the vehicle 1 is suppressed from going beyond the target stop position PT after the second wheel 5-2 climbs over the difference-in-level LD.

On the other hand, when the remaining distance DR is relatively long, the target driving force F* is set relatively large. In this case, the overshoot of the driving force F as shown in FIG. 5 may occur. However, since the remaining distance DR to the target stop position PT is long, the vehicle 1 does not go beyond the target stop position PT. Therefore, the overshoot of the driving force F is permissible. Moreover, when the target driving force F* is large, the driving force F after the second wheel 5-2 climbs over the difference-in-level LD is large as well. Therefore, the vehicle 1 promptly reaches the target stop position PT. This means that the vehicle guidance control is executed more efficiently.

As described above, the same effects as in the case of the above-described first embodiment can be obtained even by the second embodiment.

### Third Embodiment

It is also possible to combine the first embodiment and the second embodiment described above. In that case, the control device 70 variably sets both the increase rate RI and the target driving force F* in the driving force increase control according to the remaining distance DR at the time of the driving force increase control. As a result, the above-described effects are further strengthened.

What is claimed is:

1. A vehicle travel assist device that assists travel of a vehicle,
the vehicle travel assist device comprising:
a control device configured to control the travel of the vehicle; and
a memory device in which travel state information indicating a travel state of the vehicle is stored, wherein
the control device is further configured to:
execute vehicle guidance control that guides the vehicle to a target stop position based on the travel state information;
during the vehicle guidance control, execute driving force increase control that increases a driving force such that a wheel of the vehicle climbs over a difference-in-level; and
variably set an increase rate of the driving force in the driving force increase control according to a remaining distance to the target stop position at a time of the driving force increase control, wherein
the increase rate in a case where the remaining distance is a first distance is higher than the increase rate in a case where the remaining distance is a second distance shorter than the first distance.

2. The vehicle travel assist device according to claim 1, wherein
the control device executes the vehicle guidance control with updating the remaining distance to the target stop position based on the travel state information.

3. The vehicle travel assist device according to claim 1, wherein
the control device is further configured to:
determine whether or not the wheel reaches the difference-in-level based on the travel state information; and
execute the driving force increase control after determining that the wheel reaches the difference-in-level.

4. The vehicle travel assist device according to claim 1, wherein
the control device variably sets a target value of the driving force in the driving force increase control according to the remaining distance to the target stop position at the time of the driving force increase control, and
the target value in the case where the remaining distance is the first distance is greater than the target value in the case where the remaining distance is the second distance.

5. A vehicle travel assist device that assists travel of a vehicle,
the vehicle travel assist device comprising:
a control device configured to control the travel of the vehicle; and
a memory device in which travel state information indicating a travel state of the vehicle is stored, wherein
the control device is further configured to:
execute vehicle guidance control that guides the vehicle to a target stop position based on the travel state information;
during the vehicle guidance control, execute driving force increase control that increases a driving force such that a wheel of the vehicle climbs over a difference-in-level; and
variably set a target value of the driving force in the driving force increase control according to a remaining distance to the target stop position at a time of the driving force increase control, wherein
the target value in a case where the remaining distance is a first distance is greater than the target value in a case where the remaining distance is a second distance shorter than the first distance.

6. The vehicle travel assist device according to claim 5, wherein
the control device is further configured to:
estimate a minimum required driving force required for the wheel to climb over the difference-in-level, based on the travel state information; and
set the target value of the driving force to the minimum required driving force or greater.
